(19) United States
(12) Patent Application Publication
(10) Pub. No.: US 2004/0197049 A1
(43) Pub. Date: Oct. 7, 2004

(54) Arrayed waveguide grating based power monitor

(76) Inventors: Yen-Ping Ho, San Jose, CA (US); Yi Ding, Milpitas, CA (US)

Correspondence Address: Timothy N. Trop, TROP, PRUNER & HU, P.C., STE 100, 8554 KATY FWY, HOUSTON, TX, 77024-1841, US

(21) Appl. No.: 10/408,598

(22) Filed: Apr. 7, 2003

(51) Int. Cl. G02B 6/26

(52) U.S. Cl. 385/27; 385/15; 385/39

(57) ABSTRACT

An arrayed waveguide may be used to separate out the highest and a next highest efficiency diffraction orders. The highest efficiency diffraction order may be used as the main signal and the next highest efficiency diffraction order may be separated by an arrayed waveguide and passed to a detector array. Thus, the next highest efficiency diffraction order for each of the channels of a wavelength division multiplexed signal may be detected for power monitoring purposes.

### BACKGROUND

This invention relates generally to optical networks and, particularly, to wavelength division multiplexed optical networks.

In a wavelength division multiplexed optical network a plurality of channels of different wavelengths are multiplexed together. It is important to know the power of each of the multiple channel optical signals.

One way to monitor the power of each of the channels is to use optical fiber splitters on every channel. Most of the signal power passes through unaffected, but a small portion of the signal is tapped through a power splitter and coupled to an optical power detector for power measurement. However, with this approach, every signal channel requires one power splitter and one detector. For high channel count applications, this fiber splitter configuration becomes extremely cumbersome and costly.

Thus, there is a need for better ways to monitor the power of a plurality of channels in a wavelength division multiplexed optical network.

### BRIEF DESCRIPTION OF THE DRAWINGS

FIG. 1 is a schematic depiction of one embodiment of the present invention; and

FIG. 2 is a hypothetical depiction of a power distribution in accordance with one embodiment of the present invention.

### DETAILED DESCRIPTION

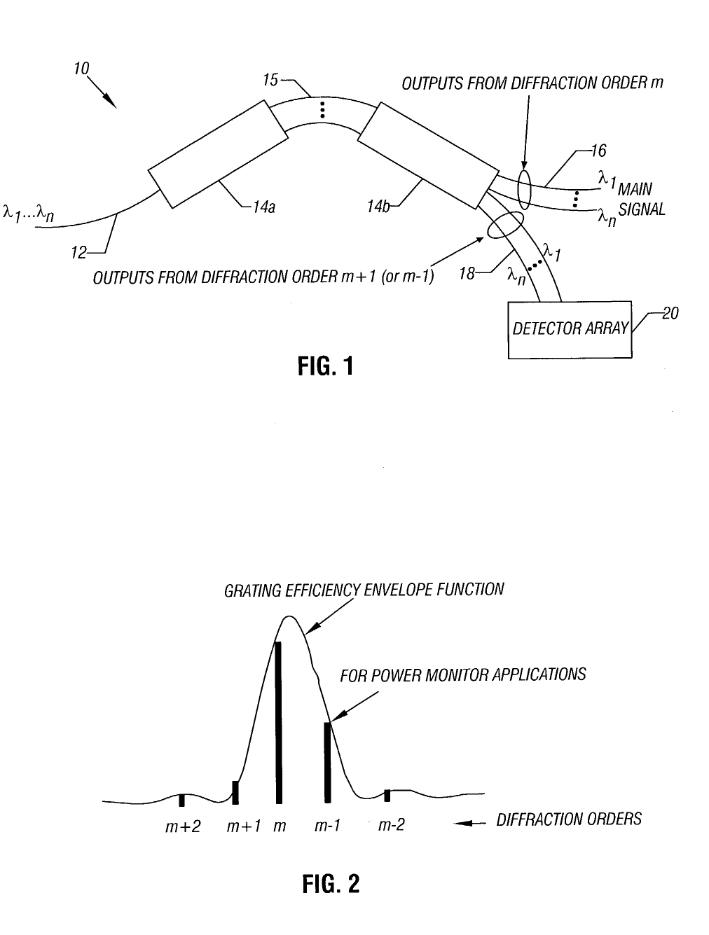

Referring to FIG. 1, an arrayed waveguide based optical system 10 receives a wavelength division multiplexed signal 12 having wavelengths 1 through N. The input waveguide 12 is coupled to a first star coupler 14a. The star coupler 14a in turn is coupled to the arrayed waveguide region 15, in turn coupled to a second star coupler 14b.

In one embodiment of the present invention at least two output waveguides 16 and 18 are coupled to the second star coupler 14b. The waveguide 18 is coupled to a power detector array 20, while the waveguide 16 includes the main multiplexed signal that continues on through the optical network. The arrayed waveguide 10 is depicted in the configuration of an optical demultiplexer, but the same principles may be applied to form a multiplexer.

The input optical beam is spread horizontally as a result of the first coupler 14a. Light passes through the region 15 to the region 14b, which is a free propagation region. Various wavelengths are coupled to different output waveguides due to the constructive and destructive interference in the region 15. The waveguide 16 operates on one diffraction order while the waveguide 18, coupled to the detector array 20, operates on the next highest power order, such as the M−1 or M+1 order, in accordance with one embodiment of the present invention. The region 15 introduces constant light path differences between neighboring waveguides so that, in the coupler 14b, various wavelengths of the input signal selectively couple to one of the output waveguides 16 and 18.

From traditional optical grating theory, a grating efficiency envelope versus imaging location can be approximated by a sinc function. The main peak has the highest efficiency and is usually used for the diffraction order of interest (M). The two side diffraction orders (M−1 and M+1) have the second highest efficiency. The spatial separation between the adjacent modes for a given wavelength is given by the equation X=λL/nₛd where L, nₛ are the length and mode refractive index of the beam free propagation region of the arrayed waveguide 10, respectively, and d is the array waveguide separation. By appropriate design of the grating shape, the efficiencies of the different orders can be modified.

As shown in FIG. 2, the grating efficiency envelope function may be adjusted to include the highest efficiency order M for the main multiplexed signal and the M−1 (or M+1) order for power monitor applications.

Thus, instead of using one group of waveguides on the output side, as is typical in arrayed waveguides, two groups of waveguides 16 and 18 may be used. One group of waveguides 16 is operated at a diffraction order M, which has the higher power, as in a conventional arrayed waveguide. The other group of waveguides 18 operates on a diffraction order M+1 or M−1 and is separated from the main waveguide group by a distance X. The waveguide 18 is coupled to the detector array 20 that measures the power of every channel.

A typical arrayed waveguide is designed such that the optical power coming out of the arrayed waveguide region 15 is coupled as efficiently as possible to the output waveguides. This means that the grating order M should be maximized and the efficiency of the other orders should be minimized.

However, in order to efficiently detect power, more power is required for the order used by the detector. One can modify the geometry or location of the arrayed waveguide to generate a secondary diffraction order, M+1 or M−1 . By generating the secondary diffraction order and capturing it in the waveguide 18, one can alter the ratio of the power distribution among the different diffraction orders, M and M+1 or M−1.

Thus, in some embodiments, without having to introduce extra devices, an arrayed waveguide based power monitor can be embedded in the arrayed waveguide based optical multiplexer or demultiplexer. Instead of using multiple single detectors, a multiple channel detector or array 10 is used, thus reducing the system cost dramatically in some embodiments.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving at least two light signals;
passing said signals through an arrayed waveguide to remove two different diffraction orders for each signal; and
directing one of said orders for each signal to a power monitor.

2. The method of claim 1 including providing a first output waveguide for the highest efficiency diffraction order and a second waveguide for a next highest efficiency diffraction order.

3. The method of claim 1 including adjusting the spacing between the pair of output waveguides to obtain the highest efficiency diffraction order and a next highest efficiency diffraction order.

4. The method of claim 1 including using an arrayed waveguide to separate said orders.

5. The method of claim 1 including using a demultiplexer to separate said orders.

6. The method of claim 5 using an array waveguide as a demultiplexer to separate said orders.

7. The method of claim 6 including using a pair of output waveguides on said arrayed waveguide, one of said output waveguides coupled to a power monitor.

8. A wavelength division multiplexed optical network comprising:
a demultiplexer to separate out a plurality of channels;
a first waveguide array coupled to said demultiplexer to receive the highest efficiency diffraction order;
a second waveguide array coupled to said demultiplexer to receive a next highest efficiency diffraction order; and
a power monitor coupled to said second waveguide array.

9. The network of claim 8 including a demultiplexer for demultiplexing multiplexed channels.

10. The network of claim 1 including an arrayed waveguide coupled to said first and second waveguide arrays.

11. The network of claim 8 including a multiple channel power monitor.

12. A power monitor for an optical network comprising:
a demultiplexer;
a first waveguide coupled to said demultiplexer to receive a highest diffraction order; and
a second waveguide coupled to said demultiplexer to receive a next highest diffraction order; and
a power monitor to monitor the power of a plurality of channels coupled to said first waveguide.

13. The power monitor of claim 12 wherein said demultiplexer is an arrayed waveguide.

14. The power monitor of claim 13 wherein said arrayed waveguide includes said first and second waveguides, each arranged with respect to one another so that said first waveguide receives the highest diffraction order and the second waveguide receives a next highest diffraction order.

15. An arrayed waveguide comprising:
an input waveguide;
an arrayed waveguide region coupled to said input waveguide; and
a pair of output waveguides arranged so that one of said output waveguides receives a highest efficiency diffraction order and the other of said output waveguides receives the next highest efficiency diffraction order.

16. The waveguide of claim 15 including a detector array to detect the power of a plurality of wavelength division multiplexed channels.
